(19) United States
(12) Patent Application Publication
(10) Pub. No.: US 2025/0101141 A1
(43) Pub. Date: Mar. 27, 2025

(54) CATALYST COMPOSITION

(71) Applicant: INEOS EUROPE AG, Rolle (CH)

(72) Inventors: Michel CLAREMBEAU, Temploux (BE); Atanas TOMOV, Croydon (GB); Roger UHRHAMMER, League City, TX (US)

(21) Appl. No.: 18/832,820

(22) PCT Filed: Jan. 24, 2023
(86) PCT No.: PCT/EP2023/051645

§ 371 Date: Jul. 24, 2024

(30) Foreign Application Priority Data
Jan. 27, 2022 (EP) 22153679.0

(51) Int. Cl. C08F 4/609; C08F 2/02; C08F 110/06

(52) U.S. Cl. CPC C08F 4/6095; C08F 2/02; C08F 110/06

(57) ABSTRACT

Compositions useful in propylene polymerization catalysts, and in particular solid, hydrocarbon-insoluble, catalyst compositions containing magnesium, titanium, and halogen and further comprising a modifier compound with structure (1):

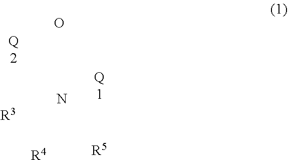

wherein Q1 is an oxygen containing group selected from CH₂—O—R¹, C(═O)—R¹ and C(═O)—O—R¹ and Q2 is selected from R² and O—R²; R¹ to R⁵ each being independently selected from H, alkyl, aryl, allyl, alkaryl, arylalkyl groups, optionally comprising one or more heteroatoms.

### FIELD AND BACKGROUND OF THE INVENTION

This invention relates to catalyst compositions, and particularly relates to modifier components used in magnesium-containing supported titanium-containing catalyst compositions.

Use of solid, transition metal-based, olefin polymerization catalyst components is well known in the art, including such solid components supported on a metal oxide, halide or other salt such as widely-described magnesium-containing, titanium halide-based catalyst components. Although many polymerization and copolymerization processes and catalyst systems have been described for polymerizing or copolymerizing alpha-olefins, it is advantageous to tailor a process and catalyst system to obtain a specific set of properties of a resulting polymer or copolymer product. For example, in certain applications, a combination of high activity, good morphology, desired particle size distribution, acceptable bulk density, and the like are required together with polymer characteristics such as stereospecificity, molecular weight distribution, and the like.

Typically, supported catalyst components useful for polymerizing propylene and higher alpha-olefins as well as for polymerizing propylene and higher olefins with minor amounts of ethylene and other alpha-olefins contain an electron donor component as an internal modifier. Such an internal modifier is an integral part of the solid supported component and is distinguished from any external electron donor component, which together with an aluminium alkyl component, may comprise the catalyst system. Typically, co-catalyst, such as aluminium alkyl, and any external electron donor are combined with the solid catalyst component, either shortly before the combination is contacted with an olefin monomer or in the presence of olefin monomer.

Selection of the internal modifier and other electron donor components can affect catalyst performance and the resulting polymer formed. A large number of organic electron donors have been described as useful in preparation of the stereospecific supported catalyst components including organic compounds containing oxygen, nitrogen, sulphur, and/or phosphorus. Such compounds include organic acids, organic acid anhydrides, organic acid esters, alcohols, ethers, aldehydes, ketones, amines, amine oxides, amides, thiols, various phosphorus acid esters and amides, and the like. Mixtures of organic electron donors have been described as useful in incorporating into supported catalyst components. Specific examples of organic electron donors typically used as internal modifiers include dicarboxylate esters, such as alkyl phthalates, succinate esters and other bidentate donors, such as diethers.

It is also known that, in addition to a co-catalyst, the external donor components of the catalyst can include several components. WO 2005/30815 and WO 2009/85649, for example, describe propylene polymerization catalysts which, in addition to one or more aluminium containing co-catalysts; include a combination of external donors, and in particular at least one alkoxysilane, which is referred to as a “selectivity control agent” (SCA) and at least one aliphatic or cycloaliphatic mono- or poly-carboxylic acids; or ester derivative thereof, which is referred to as an “activity limiting agent” (ALA).

Further, numerous individual processes or process steps have been disclosed to produce improved supported, magnesium-containing, titanium-containing, electron donor-containing olefin polymerization or copolymerization catalysts. For example, U.S. Pat. No. 4,866,022 discloses a method for forming an advantageous alpha-olefin polymerization or copolymerization catalyst or catalyst component which involves a specific sequence of individual process steps. U.S. Pat. No. 4,540,679, discloses a process for the preparation of a magnesium hydrocarbyl carbonate by reacting a suspension of a magnesium alcoholate in an alcohol with carbon dioxide and reacting the magnesium hydrocarbyl carbonate with a transition metal component. U.S. Pat. No. 4,612,299, discloses a process for the preparation of a magnesium carboxylate by reacting a solution of a hydrocarbyl magnesium compound with carbon dioxide to precipitate a magnesium carboxylate and reacting the magnesium carboxylate with a transition metal component.

Particular uses of propylene polymers depend upon the physical properties of the polymer, such as molecular weight, viscosity, stiffness, flexural modulus, and polydispersity index (molecular weight distribution (M_{w}/Mₙ). In addition, polymer or copolymer morphology typically depends upon catalyst morphology.

### SUMMARY OF THE INVENTION

The present invention relates to catalyst compositions and in particular comprising a new modifier component.

Thus, in a first aspect the present invention provides a solid, hydrocarbon-insoluble, catalyst composition containing magnesium, titanium, and halogen and further comprising a modifier compound with a structure (1):

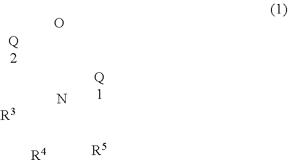

wherein Q1 is an oxygen containing group selected from CH₂—O—R¹, C(═O)—R¹ and C(═O)—O—R¹ and Q2 is selected from R² and O—R²; R¹ to R⁵ each being independently selected from H, alkyl, aryl, allyl, alkaryl, arylalkyl groups, optionally comprising one or more heteroatoms.

### DETAILED DESCRIPTION

The present invention relates to a catalyst composition, and in particular to be used for polymerisation of olefins. As used herein the term “catalyst composition” includes both “catalyst components” and “catalyst systems”, and where:
The term “catalyst component” refers, as generally used in the art, to a composition containing magnesium, titanium, and halogen and an internal modifier. “Catalyst components” are generally combined or used with one or more co-catalysts to provide a “catalyst system” to polymerise olefins. In the present invention, when the catalyst composition is a catalyst component, then the modifier compound with a structure (1) is an internal donor in the catalyst component.
The term “catalyst system” (which may in some embodiments also be referred to simply as a “catalyst”) generally refers to a composition comprising a catalyst component in combination with one or more co-catalyst components. A catalyst system will generally comprise an internal modifier, which is part of the catalyst component, and will usually also comprise an external modifier which is separately provided. In one embodiment, therefore, when the catalyst composition is a catalyst system, then the modifier compound with a structure (1) may be an external modifier.

It is most preferred in the present invention that the modifier with structure (1) is an internal modifier, and most particularly that the catalyst composition is a catalyst component where the modifier with structure (1) is an internal modifier. The catalyst component is particularly useful, in conjunction with a co-catalyst, as a catalyst system for the polymerization of olefins.

For avoidance of doubt, the modifier is, and may also be considered as, an electron donor compound.

(As used herein the term “modifier” is used as short-hand to refer to the modifier compound of structure (1), and the terms “modifier” and “modifier compound” may be used interchangeably. The term “modifier” is used in the present invention to provide a clear distinction in terminology for the modifier of structure (1) from other electron donors which may be present in any aspect or embodiment.)

The terms “internal” and “external” as used in the context of modifiers/electron donors are well understood in the art. In general, and as used herein, the term “internal” when used in reference to a modifier (or other electron donor) refers to a compound which is an integral part of a solid supported catalyst component. Generally, this is achieved by adding the internal modifier (or other electron donor) during the catalyst preparation. In contrast, the term “external” when used in reference to a modifier (or other electron donor) refers to a compound which is combined with a solid catalyst component either shortly before the combination is contacted with an olefin monomer or in the presence of olefin monomer e.g. in a reactor.

In the present invention Q1 is an oxygen containing group selected from CH₂—O—R¹, C(═O)—R¹ and C(═O)—O—R¹.

In a first preferred embodiment, Q1 is selected from C(═O)—R¹ and C(═O)—O—R¹. The structure (1) is then:

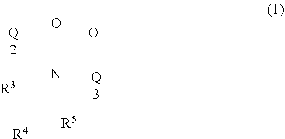

wherein Q3 is selected from R¹ and O—R¹ (and wherein Q2 is selected from R² and O—R²).

Preferably in this embodiment Q1 is C(═O)—O—R¹/Q3 is O—R¹.

In a second preferred embodiment, Q1 is CH₂—O—R¹. The structure (1) is then:

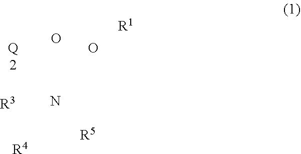

(wherein Q2 is selected from R² and O—R².)

In all embodiments, including in the first and second embodiments, it is preferred that Q2 is O—R².

In general, and also in both the first and second preferred embodiments R¹ to R⁵ are each independently selected from H, alkyl, aryl, allyl, alkaryl and arylalkyl groups, optionally comprising one or more heteroatoms. Preferably, however, none of R¹ to R⁵ comprise heteroatoms.

In relation to R¹, R¹ is preferably an alkyl group, an aryl group or an alkaryl group. The alkyl group, when present, may be linear, branched or cyclic, and preferably has 1 to 20 carbon atoms, such as 1 to 10 carbon atoms. The aryl group or alkaryl group, when present, preferably has 1 to 20 carbon atoms, such as 1 to 10 carbon atoms.

Preferably, R¹ is an alkyl group, an aryl group or an alkaryl group which does not comprise any heteroatoms i.e. comprises solely C and H atoms.

In one preferred option R¹ is an alkyl group, and most preferably selected from methyl, ethyl, propyl and butyl groups.

In another preferred option, particularly in a structure according to the first preferred embodiment, R¹ is R¹ is an aryl group or an alkaryl group, and most preferably a phenyl group.

In all embodiments, R¹ may be linked to R⁵ i.e. to form a cyclic group.

In relation to R², R² is preferably an alkyl group, an aryl group or an alkaryl group. The alkyl group, when present, may be linear, branched or cyclic, and preferably has 1 to 20 carbon atoms, such as 1 to 10 carbon atoms. The aryl group or alkaryl group, when present, preferably has 1 to 20 carbon atoms, such as 1 to 10 carbon atoms.

Preferably, R² is an alkyl group, an aryl group or an alkaryl group which does not comprise any heteroatoms i.e. comprises solely C and H atoms. More preferably, R² is an alkyl group which does not comprise any heteroatoms. R² is most preferably selected from methyl, ethyl, propyl and butyl groups.

In all embodiments, R² may be linked to R³ i.e. to form a cyclic group.

In relation to wherein R³ to R⁵, these are each independently selected from H, alkyl, aryl, allyl, alkaryl and arylalkyl groups, optionally comprising one or more heteroatoms. Preferably R³ to R⁵ do not comprise any heteroatoms.

Preferably R³ to R⁵ are each independently selected from H and alkyl. The alkyl group may be linear, branched or cyclic, and preferably has 1 to 20 carbon atoms, such as 1 to 10 carbon atoms. More preferably, any alkyl group is an alkyl group which does not comprise any heteroatoms i.e. comprises solely C and H atoms.

In one embodiment, R³ to R⁵ are each independently selected from H, methyl, ethyl, propyl and butyl groups. For example, each of R³ to R⁵ may be H. As another example, R³ and R⁵ may be methyl and R⁴ may be H.

Particularly preferred structures (1) in the first embodiment include:
(A) Q3 is O—R¹, R¹ being ethyl; Q2 is O—R², R² being ethyl; R³ to R⁵ are all H.
(B) Q3 is O—R¹, R¹ being ethyl; Q2 is O—R², R² being ethyl; R³ and R⁵ are methyl and R⁴ is H.
(C) Q3 is R¹, R¹ phenyl, Q2 is O—R², R² being ethyl; R³ to R⁵ are all H.

Particularly preferred structures (1) in the second embodiment include:
(A) R¹ being methyl; Q2 being O—R², R² being ethyl; R³ to R⁵ all being H.

In embodiments two of R³ to R⁵ may be linked to form a cyclic group. In a preferred (hereinafter third) embodiment R⁴ and R⁵ are linked and the compound has the following structure (2):

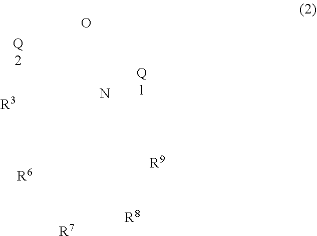

R⁶ to R⁹ each being independently selected from H, alkyl, aryl, allyl, alkaryl, arylalkyl groups, optionally comprising one or more heteroatoms.

Preferably, none of R⁶ to R⁹ comprise heteroatoms.

In relation to structure (2), Q1/R¹, Q2/R² and R³ are as defined for structure (1), including the preferred options described before. This includes that, preferably, none of these comprise heteroatoms (e.g. in a most preferred option none of R¹ to R⁹ comprise heteroatoms.)

In a fourth preferred embodiment, one preferred structure according to the third embodiment comprises Q1 selected from C(═O)—R¹ and C(═O)—O—R¹. The structure (2) is then:

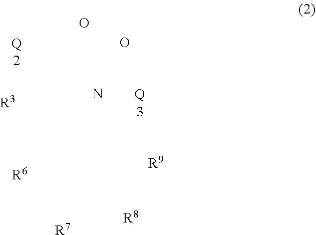

wherein Q3 is selected from R¹ and O—R¹ (and wherein Q2 is selected from R² and O—R²).

Preferably in this embodiment Q1 is C(═O)—O—R¹/Q3 is O—R¹.

In a fifth preferred embodiment, another preferred structure according to the third embodiment comprises Q1 is CH₂—O—R¹. The structure (2) is then:

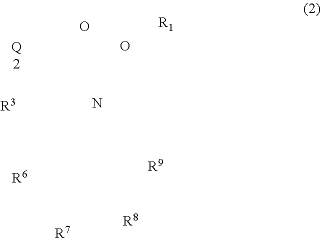

(wherein Q2 is selected from R² and O—R².)

In all of these third to fifth embodiments it is preferred that Q2 is O—R².

Particularly preferred in all of the third to fifth embodiments is that R¹ and R² are both alkyl groups, and most preferably each selected from methyl, ethyl, propyl and butyl groups; and that R³ is selected from H and an alkyl group, preferably from H and methyl, ethyl, propyl and butyl groups.

Preferably R⁶ to R⁹ in the structure (2) are each independently selected from H and alkyl. The alkyl groups may be linear, branched or cyclic, and preferably have 1 to 20 carbon atoms, such as 1 to 10 carbon atoms. More preferably, any alkyl group is an alkyl group which does not comprise any heteroatoms i.e. comprises solely C and H atoms.

More preferably R⁶ to R⁹ are each independently selected from H, methyl, ethyl, propyl and butyl groups, and most preferably R⁶ to R⁹ are each H.

Yet more preferably R³, R⁶ to R⁹ are each independently selected from H, methyl, ethyl, propyl and butyl groups, and most preferably R³, R⁶ to R⁹ are each H.

Particularly preferred structures (2) in the fourth embodiment include:
(A) Q3 is O—R¹, R¹ being ethyl; Q2 is O—R², R² being ethyl; R³ and R⁶ to R⁹ are all H.
(B) Q3 is O—R¹, R¹ being butyl; Q2 is O—R², R² being butyl; R³ and R⁶ to R⁹ are all H.
(C) Q3 is O—R¹, R¹ being butyl; Q2 is O—R², R² being ethyl; R³ and R⁶ to R⁹ are all H.

Particularly preferred structures (2) in the fifth embodiment include:
(A) R¹ being methyl; Q2 being O—R², R² being ethyl; R³ and R⁶ to R⁹ all being H.

More generally in the present invention, and although not preferred, any of R¹ to R⁹ may be substituted with heteroatoms. Examples include oxygen, sulphur, nitrogen, phosphorus, silicon or halogens. For example, an alkyl group used in this invention may be substituted with a nitrogen in the form of an amine group, with nitrogen and oxygen in the form of an amide group, or with chloro, bromo or silyl groups. Cyclic alkyl or aryl structures may contain hetero atoms such as oxygen, sulphur, nitrogen, silicon, and phosphorus.

As already noted, however, preferably all of R¹ to R⁵, and also R⁶ to R⁹ when present, do not comprise any heteroatoms i.e. comprise solely carbon and hydrogen.

As already noted, in preferred embodiments the catalyst composition is a catalyst component in which the modifier, particularly one of the preferred modifiers described above, is present as an internal modifier.

It should also be noted that mixtures of modifier compounds described by the structure (1) (including also those of structure (2) may be used as well as mixtures of such compounds with other donor compounds known in the art. Examples of this are described further below.

The solid, hydrocarbon-insoluble, catalyst composition generally comprises titanium compounds supported on magnesium-containing compounds. In preferred embodiments, where the modifier is an internal modifier, then the supported titanium-containing olefin polymerization catalyst component typically is formed by reacting a titanium compound, a modifier compound and a magnesium-containing compound. Optionally, such supported titanium-containing reaction product may be further treated or modified by further chemical treatment.

Suitable magnesium-containing compounds include magnesium halides; a reaction product of a magnesium halide such as magnesium chloride or magnesium bromide with an organic compound, such as an alcohol or an organic acid ester, or with an organometallic compound of metals of Groups I-III; magnesium alcoholates; or magnesium alkyls.

A particularly preferred titanium compound for use in such steps is TiCL, although numerous other species, such as other titanium (IV) halides or titanium alcoholates are also known to be suitable.

The present invention is not limited to a catalyst composition prepared by any specific method of preparation.

In preferred embodiments, for example, a catalyst component comprising an internal modifier may be prepared by reacting the magnesium and titanium compounds and the modifier compound in any suitable order. For example, the catalyst components may be prepared by reacting the magnesium and titanium compounds first, and then incorporation of the modifier compound. Alternatively, the modifier may be incorporated prior to the titanium compound, during the addition of the titanium compound, or (in multiple steps) in a combination thereof.

Generally, the aforesaid modifier compounds and titanium compounds may be contacted with solid particles of a magnesium compound in the presence of an inert hydrocarbon or halogenated diluent, although other suitable techniques can be employed. Suitable diluents are substantially inert to the components employed and are liquid at the temperature and pressure employed.

Most typically, a solution or solutions of titanium tetrachloride and the modifier compound is/are contacted with a magnesium-containing material, for example by addition to a slurry of magnesium containing particles in a suitable hydrocarbon. Such magnesium-containing material typically is in the form of discrete particles and may contain other materials such as transition metals and organic compounds. Also, a mixture of magnesium chloride, titanium tetrachloride and the modifier may be formed into an active catalyst component by ball-milling.

In a preferred method, however, a slurry of a magnesium containing material is first contacted with a solution of the modifier, typically with stirring. The obtained solution is then be treated with a suitable titanium containing species. Several steps may be applied for addition of the internal donor or the titanium, or both.

In one particularly advantageous procedure, magnesium chloride-based support particles suspended in a liquid hydrocarbon diluent, such as toluene, are first contacted with titanium tetrachloride, and then with a modifier compound, these two contacting steps being repeated one or more times, before a final contacting step with titanium tetrachloride (i.e. without the subsequent addition step of further modifier). The diluent used may be decanted between steps and fresh diluent added prior to the next step. After the final step the diluent is removed, and the product is washed one or more times with a liquid hydrocarbon, such as heptane, and then dried.

The conditions in such steps are known in the art. The steps are usually performed at elevated temperatures, typically from 75 to 135° C., and at normal or slightly elevated pressures from 1 to 3 bar. Typical individual treatment times for each step may vary from several minutes to several hours, usually from 0.25 to 3 hours.

As a result of the preparation steps, there is obtained a solid reaction product suitable for use as a catalyst component. Prior to such use, it is desirable to remove incompletely reacted starting materials from the solid reaction product. This is conveniently accomplished by washing the solid, after separation from any preparative diluent, with a suitable solvent, such as a liquid hydrocarbon or chlorocarbon, preferably within a short time after completion of the preparative reaction because prolonged contact between the catalyst component and unreacted starting materials may adversely affect catalyst component performance.

Although not required, the final solid reaction product may be washed with an inert liquid hydrocarbon or halogenated hydrocarbon before contact with a Lewis acid. If such a wash is conducted, it is preferred to substantially remove the inert liquid prior to contacting the washed solid with Lewis acid.

(For avoidance of doubt, a catalyst system according to the present invention where the modifier of structure (1) is an external donor may be prepared by first preparing a catalyst component in a similar manner to the above except using an internal electron donor which is not a modifier of structure (1), and subsequently using the modifier as an external donor.)

In a typical catalyst composition, and preferably catalyst component, in the present invention, the magnesium to titanium molar ratio is at least 1:1, and preferably up to 20:1. Greater amounts of magnesium may be employed without adversely affecting catalyst system performance, but typically there is no need to exceed a magnesium to titanium ratio of 20:1. More preferably, the magnesium to titanium ratio ranges from 2:1 to 20:1, such as from 5:1 to 20:1.

The catalyst composition of the present invention generally comprises from 1 to 6 weight percent titanium, from 10 to 25 weight percent magnesium, and from 45 to 65 weight percent halogen. Preferably, the catalyst composition comprises from 2 to 4 weight percent titanium, from 15 to 21 weight percent magnesium and from 55 to 65 weight percent chlorine.

The modifier component, when used as an internal modifier, is typically incorporated into the solid catalyst component in a molar ratio of modifier to titanium at least 0.1:1 and/or up to 10:1. The molar ratio is preferably at least 0.2:1, and more preferably at least 0.4:1. The molar ratio is preferably up to 5:1, such as up to 2:1. A molar ratio of modifier to titanium in the range of 0.4:1 to 1.2:1 is most preferred.

As already noted, in an embodiment of the present invention, mixtures of electron donors may be used. This includes mixtures of two or more modifier compounds described by the structure (1) as well as mixtures of compounds of the structure (1) with other electron donor compounds known in the art. (For avoidance of doubt, reference here and hereinafter to compounds of the structure (1) includes also those of structure (2), since these also fall within the scope of structure (1).)

For example, where the modifier of structure (1) is used as an internal modifier (internal electron donor), then the modifier may be used as a component of an internal donor mixture. Preferably, in these embodiments the internal donor mixture is a mixture of at least one compound of the structure (1) with at least one other electron donor compound known in the art (hereinafter referred to as an “additional internal donor”).

In one embodiment the additional internal donor may be a dialkylphthalate. For example, the additional internal donor may be a dialkylphthalate wherein each alkyl group may be the same or different and contains from 3 to 5 carbon atoms, preferably a dibutylphthalate and more preferably is di-n-butylphthalate or di-i-butylphthalate. Alternatively, the additional internal donor may be a dialkylphthalate wherein each alkyl group may be the same or different and each contains at least 6 carbon atoms, preferably up to 10 atoms. Particular dialkylphthalates which are suitable include dihexylphthalate and dioctylphthalate.

In an alternative, the additional internal donor may be a dicycloaliphatic ester of an aromatic dicarboxylic acid wherein each cycloaliphatic moiety may be the same or different and each contains from 5 to 7 carbon atoms, and preferably contains 6 carbon atoms. Preferably the ester is a dicycloaliphatic diester of an ortho aromatic dicarboxylic acid. Particular dicycloaliphatic esters that are suitable include dicyclopentylphthalate, dicyclohexylphthalate, and di-(methylcyclopentyl)-phthalate.

In another option, the additional internal donor may be an alkyl-arylalkyl phthalate wherein the alkyl moiety contains 2 to 10, preferably 3 to 6, carbon atoms, and the arylalkyl moiety contains from 7 carbon atoms up to 10, preferably up to 8, carbon atoms. Particularly, alkyl-arylalkyl phthalates suitable include benzyl n-butyl phthalate and benzyl i-butyl phthalate.

Also, the additional internal donor may be an alkyl ester of an aliphatic monocarboxylic acid wherein carboxylic acid moiety contains 2 to 20, preferably 3 to 6, carbon atoms and the alkyl moiety contains from 1 to 3 carbon atoms. Preferably the additional internal donor is an alkyl ester of an aliphatic monocarboxylic acid. Particular alkyl esters that are suitable include methyl valerate, ethyl pivalate, methyl pivalate, methyl butyrate, and ethyl propionate.

In another alternative, such additional internal donor also may be an alkyl ester of an aromatic monocarboxylic acid wherein the monocarboxylic acid moiety contains from 6 to 8 carbon ators and the alkyl moiety contains from 1 to 3 carbon atoms. Particular alkyl esters that are suitable in this case include methyl toluate, ethyl toluate, methyl benzoate, ethyl benzoate and propyl benzoate.

In a yet further alternative, the additional internal donor also may be a 1,3-diether, and particularly a 2,2-di-substituted-1,3-diether. Preferred examples include 2-isopropyl-2-isobutyl-1,3-dimethoxypropane, 2,2-diisobutyl-1,3-dimethoxypropane, 2-isopropyl-2-isopentyl-1,3-dimethoxypropane, 2,2-dicyclohexyl-1,3-dimethoxypropane, 2,2-bis(cyclohexylmethyl)-1,3-dimethoxypropane, and 9,9-bis(methoxymethyl) fluorene. Among these, 2-isopropyl-2-isobutyl-1,3-dimethoxypropane, 2-isopropyl-2-isopentyl-1,3-dimethoxypropane, and 9,9-bis(methoxymethyl) fluorene are preferable.

The mole ratio of the additional internal donor to the (internal) modifier in all options above may, for example, range from 5:95 to 95:5.

The catalyst composition of this invention may be used in the polymerization or copolymerization of alpha olefins. Pre-polymerization or encapsulation of the catalyst composition may be carried out prior to being used in the polymerization. A particularly useful pre-polymerization procedure is described in U.S. Pat. No. 4,579,836.

Typically, the catalyst composition of the present invention comprises or is used for polymerization in conjunction with a cocatalyst component. The cocatalyst component may be a Group II or III metal alkyl. Useful Group II and IIIA metal alkyls are compounds of the formula MRₘ wherein M is a Group II or III metal, each R is independently an alkyl radical of 1 to 20 carbon atoms, and m corresponds to the valence of M. Examples of useful metals, M, include magnesium, calcium, zinc, cadmium, aluminium, and gallium. Examples of suitable alkyl radicals, R, include methyl, ethyl, butyl, hexyl, decyl, tetradecyl, and eicosyl. From the standpoint of catalyst composition performance, preferred Group II and IIIA metal alkyls are those of magnesium, zinc, and aluminium wherein the alkyl radicals contain 1 to 12 carbon atoms. Specific examples of such compounds include Mg(CH₃)₂, Mg(C₂H₅)₂, Mg(C₂H₅)(C₄H₉), Mg(C₄H₉)₂, Mg(C₆H₁₃)₂, Mg(C₁₂H₂₅)₂, Zn(CH₃)₂, Zn(C₂H₅)₂, Zn(C₆H₉)₂, Zn(C₄H₉) (C₈H₁₇), Zn(C₆H₁₃), Zn(C₅H₁₃)₃, and Al(C₁₂H₂₅)₃. A magnesium, zinc, or aluminium alkyl containing 1 to 6 carbon atoms per alkyl radical may preferably be used.

Aluminium alkyls are most preferred as co-catalyst and even more preferably trialkylaluminiums containing 1 to 6 carbon atoms per alkyl radical. Particularly triethylaluminium and triisobutylaluminium or a combination thereof can be used.

If desired, however, metal alkyls having one or more halogen or hydride groups can be employed, such as ethylaluminium dichloride, diethylaluminium chloride, and the like.

A catalyst system for the polymerization or copolymerization of alpha olefins may be formed by combining a supported titanium-containing catalyst component according to the present invention and a co-catalyst component, preferably an alkyl aluminium compound.

Typically, useful aluminium-to-titanium molar ratios in such catalyst systems are 10:1 to 2000:1 and preferably 50:1 to 1500:1.

Typically, a catalyst component according to the present invention is used for polymerization in conjunction with a co-catalyst and also with one or more further electron donor compounds. In particular, in one embodiment of the present invention modifiers of structure (1) may be used as both internal and external electron donors for the catalyst, either alone or in combination with other suitable electron donors.

In preferred embodiments, the modifier is used as an internal modifier (or internal electron donor), optionally as part of an internal donor mixture as described, and is further used in conjunction with one or more other external electron donors.

Typical aluminium-to-external electron donor molar ratios in such catalyst systems are 2 to 60.

A preferred external electron donor is a silane. Typical aluminium-to-silane compound molar ratios in such catalyst systems are 3 to 50. Preferable silanes include alkyl-, aryl-, and/or alkoxy-substituted silanes containing hydrocarbon moieties with 1 to 20 carbon atoms. Especially preferred are silanes having a formula: SiY₄, wherein each Y group is the same or different and is an alkyl or alkoxy group containing 1 to 20 carbon atoms. Preferred silanes include isobutyltrimethoxysilane, diisobutyldimethoxysilane, diisopropyldimethoxysilane, n-propyltriethoxysilane, isobutylmethyldimethoxysilane, isobutylisopropyldimethoxysilane, dicyclopentyldimethoxysilane, tetraethylorthosilicate, dicyclohexyldimethoxysilane, diphenyldimethoxysilane, di-t-butyldimethoxysilane, and t-butyltrimethoxysilane.

Other compounds useful as external electron donors, either as an alternative to or in addition to one or more silanes, are organic compounds containing oxygen, nitrogen, sulphur, and/or phosphorus. Such compounds include organic acids, organic acid anhydrides, organic acid esters, alcohols, ethers, aldehydes, ketones, amines, amine oxides, amides, thiols, various phosphorus acid esters and amides, and the like. Mixtures of external electron donors may be used.

Particular organic acids and esters are benzoic acid, halobenzoic acids, phthalic acid, isophthalic acid, terephthalic acid, and the alkyl esters thereof wherein the alkyl group contains 1 to 6 carbon atoms such as methyl chlorobenzoates, butyl benzoate, isobutyl) benzoate, methyl anisate, ethyl anisate, methyl p-toluate, hexylbenzoate, and cyclohexyl-benzoate, and diisobutyl phthalate as these give good results in terms of activity and stereospecificity and are convenient to use.

The catalyst composition of this invention is useful in the stereospecific polymerization or copolymerization of alpha-olefins containing 3 or more carbon atoms such as propylene, butene-1, pentene-1, 4-methylpentene-1 and hexene-1, as well as mixtures thereof and mixtures thereof with ethylene.

Thus, in a second aspect, the present invention provides a process to polymerize propylene or a mixture of propylene and ethylene or a C₄-C₅ alpha-olefin, which process comprises using a catalyst composition according to the first aspect.

The catalyst composition of this invention is particularly effective in the stereospecific polymerization or copolymerization of propylene or mixtures thereof with up to 30 mole percent ethylene or a higher alpha-olefin. Highly crystalline polyalpha-olefin homopolymers or copolymers can be prepared by contacting at least one alpha-olefin with the catalyst composition under polymerization or copolymerization conditions. Such conditions include polymerization or copolymerization temperature and time, pressure(s) of the monomer(s), avoidance of contamination of catalyst, choice of polymerization or copolymerization medium in slurry processes, the use of additives to control homopolymer or copolymer molecular weights, and other conditions well known to persons skilled in the art. Slurry-, bulk-, and vapor-phase polymerization or copolymerization processes are contemplated herein.

The amount of the catalyst composition to be used varies depending on choice of polymerization or copolymerization technique, reactor size, monomer to be polymerized or copolymerized, and other factors known to persons of skill in the art, and can be determined on the basis of the examples appearing hereinafter. Typically, the catalyst composition of this invention is used in amounts ranging from 0.2 to 0.02 milligrams of catalyst to gram of polymer or copolymer produced.

Irrespective of the polymerization or copolymerization process employed, polymerization or copolymerization should be carried out at temperatures sufficiently high to ensure reasonable polymerization or copolymerization rates and avoid unduly long reactor residence times, but not so high as to result in the production of unreasonably high levels of stereo-random products due to excessively rapid polymerization or copolymerization rates. Generally, temperatures range from 0° to 120° C. with a range of from 20° C. to 95° C. being preferred from the standpoint of attaining good catalyst performance and high production rates. More preferably, polymerization is carried out at temperatures ranging from 50° C. to 80° C.

Olefin polymerization or copolymerization may be carried out at monomer pressures of atmospheric or above. Generally, monomer pressures range from 140 to 4100 kPa, although in vapor phase polymerizations or copolymerizations monomer pressures should not be below the vapor pressure at the polymerization or copolymerization temperature of the alpha-olefin to be polymerized or copolymerized.

The polymerization or copolymerization time will generally range from % % to several hours in batch processes with corresponding average residence times in continuous processes. Polymerization or copolymerization times ranging from 1 to 4 hours are typical in autoclave-type reactions. In slurry processes, the polymerization or copolymerization time can be regulated as desired. Polymerization or copolymerization times ranging from/to several hours are generally sufficient in continuous slurry processes.

Diluents suitable for use in slurry polymerization or copolymerization processes include alkanes and cycloalkanes such as pentane, hexane, heptane, n-octane, isooctane, cyclohexane, and methylcyclohexane; alkylaromatics such as toluene, xylene, ethylbenzene, isopropylbenzene, ethyl toluene, n-propyl-benzene, diethylbenzenes, and mono- and dialkylnaphthalenes; halogenated and hydrogenated aromatics such as chlorobenzene. Chloronaphthalene, ortho-dichlorobenzene, tetrahydro-naphthalene, decahydronaphthalene; high molecular weight liquid paraffins or mixtures thereof, and other well-known diluents. It often is desirable to purify the polymerization or copolymerization medium prior to use, such as by distillation, percolation through molecular sieves, contacting with a compound such as an alkylaluminium compound capable of removing trace impurities, or by other suitable means.

Examples of gas-phase polymerization or copolymerization processes in which the catalyst composition of this invention may be used include both stirred bed reactors and fluidized bed reactor systems and are described in U.S. Pat. Nos. 3,957,448; 3,965,083; 3,971,786; 3,970,611; 4,129,701; 4,101,289; 3,652,527; and 4,003,712. Typical gas phase olefin polymerization or copolymerization reactor systems comprise at least one reactor vessel to which olefin monomer and catalyst components can be added and which contain an agitated bed of forming polymer particles. Typically, catalyst components are added together or separately through one or more valve-controlled ports in the single or first reactor vessel. Olefin monomer, typically, is provided to the reactor through a recycle gas system in which unreacted monomer removed as off-gas and fresh feed monomer are mixed and injected into the reactor vessel. For production of impact copolymers, homopolymer formed from the first monomer in the first reactor is reacted with the second monomer in the second reactor. A quench liquid, which can be liquid monomer, can be added to polymerizing or copolymerizing olefin through the recycle gas system in order to control temperature.

Irrespective of polymerization or copolymerization technique, polymerization or copolymerization is generally carried out under conditions that exclude water and other materials that act as catalyst poisons. Also, polymerization or copolymerization can be carried out in the presence of additives to control polymer or copolymer molecular weights. Hydrogen is typically employed for this purpose in a manner well known to persons of skill in the art. Although not usually required, upon completion of polymerization or copolymerization, or when it is desired to terminate polymerization or copolymerization or at least temporarily deactivate the catalyst, the catalyst can be contacted with water, alcohols, acetone, or other suitable catalyst deactivators in a manner known to persons of skill in the art.

The products produced are normally solid, predominantly isotactic polyalpha-olefins. Homopolymer or copolymer yields are sufficiently high relative to the amount of catalyst employed so that useful products can be obtained without separation of catalyst residues. Further, levels of stereo-random by-products are sufficiently low so that useful products can be obtained without separation thereof. The polymeric or copolymeric products produced in the presence of the catalyst can be fabricated into useful articles by extrusion, injection moulding, and other common techniques.

The polymer product primarily contains a high crystalline polymer of propylene. Polymers of propylene having substantial polypropylene crystallinity content now are well-known in the art. It has long been recognized that crystalline propylene polymers, described as “isotactic” polypropylene, contain crystalline domains interspersed with some non-crystalline domains. Non-crystalline domains can be due to defects in the regular isotactic polymer chain which prevent perfect polymer crystal formation. The extent of polypropylene stereoregularity in a polymer can be measured by well-known techniques such as isotactic index, crystalline melting temperature, flexural modulus, and, recently by determining the relative percent of meso pentads (% m4) by carbon-13 nuclear magnetic resonance (¹³C NMR).

The invention described herein is illustrated, but not limited, by the following examples.

### EXAMPLES

A series of supported catalyst components (compositions with the modifier of structure (1) as an internal donor) according to the present invention have been prepared and tested for propylene polymerisation as described below.

### Preparation of Catalysts

The modifiers used in the Examples are shown in Table 1. In the present Examples each modifier was used in two different amounts in the catalyst, again as shown in Table 1. Morphology-controlled MgCl₂-THF catalyst support was prepared as U.S. Pat. No. 4,988,856, Example 1, Steps A through C.

### Example 1a

A 1 litre Buchi reactor was charged with catalyst support (11.5 g), toluene (125 mL), and then TiCl₄ (105 mL). The mixture was heated to 90° C. while stirring at 600 RPM. When the temperature reached 90° C., Modifier-1 (0.75 mL) was added, and the mixture was held at 90° C. After 1 hour, stirring was stopped, the mixture was allowed to settle, and the supernate was decanted. Toluene (125 mL) and TiCl₄ (105 mL) were added to the resulting solid, and the mixture was heated with stirring. At 90 C, a further amount of Modifier-1 (0.38 mL) was added, the temperature increased to 100° C., and held at 100 C for 1 hour. The fluids were removed by filtration. Toluene (125 mL) and TiCl₄ (105 mL) were added, the mixture was heated to 105 C with stirring, and held at 105° C. for 0.5 hours. The fluids were removed by filtration, and the resulting solid catalyst was washed five times with heptane (200 mL portions), and dried under a stream of nitrogen in a drybox. Analytical results of the catalyst are shown in Table 1.

### Example 1b

This catalyst was made using a procedure similar to EXAMPLE 1a, except that the amounts of Modifier-1 added in the first and second titanations was 1.5 mL and 1.2 ml.

### Example 1c

A 1 litre Buchi reactor was charged with magnesium ethoxide (20 g), toluene (125 mL) and then TiCl₄ (210 mL). The mixture was heated to 75° C. while stirring at 600 RPM. After holding for 1 hour at 75° C., the fluids were removed by filtration. Toluene (125 mL) and TiCl₄ (210 mL) were added, and the mixture was heated. When the temperature reached 75° C., a mixture of 2-isopropyl-2-isobutyl-1,3-dimethoxypropane (IBIP, 5.4 mL) and Modifier-1 (0.6 mL) was added. The reaction mixture was held at 105° C. for 2 hours, and the fluids were removed by filtration. TiCl₄ (210 mL) was added, the mixture was heated for 2.5 hours. The fluids were removed by filtration, TiCl₄ (210 mL) was added, and the mixture was heated for 0.5 hours. The fluids were removed by filtration, and the resulting solid catalyst was washed five times with heptane (200 mL portions), and dried under a stream of nitrogen in a drybox. Analytical results of the catalyst are shown in Table 1.

### Example 1d

This catalyst was made using a procedure similar to EXAMPLE 1c, except that the amounts of 2-isopropyl-2-isobutyl-1,3-dimethoxypropane and Modifier-1 were changed to 5.7 ml and 0.3 mL, respectively.

### Example 2

This catalyst was made using a procedure similar to EXAMPLE 1c, except that Modifier-2 (4 mL) was added in place of the mixture of 2-isopropyl-2-isobutyl-1,3-dimethoxypropane and Modifier-1.

### Example 3

This catalyst was made using a procedure similar to EXAMPLE 1a, except that Modifier-3 (0.9 mL and 0.45 mL) was added in the first and second titanations in place of Modifier-1.

### Example 4

This catalyst was made using a procedure similar to EXAMPLE 1c, except that Modifier-4 (3.75 mL) was added in place of the mixture of 2-isopropyl-2-isobutyl-1,3-dimethoxypropane and Modifier-1.

### Example 5a

This catalyst was made using a procedure similar to EXAMPLE 1a, except that Modifier-5 (1.15 mL and 0.6 mL) was added in the first and second titanations in place of Modifier-1.

### Example 5b

This catalyst was made using a procedure similar to EXAMPLE 5a, except that the amounts of Modifier-5 added in the first and second titanations were 2.3 mL and 1.5 ml.

### Example 6

This catalyst was made using a procedure similar to EXAMPLE 1a, except that Modifier 6 (1.05 mL and 0.5 mL) was added in the first and second titanations in place of Modifier-1.

### Example 7

This catalyst was made using a procedure similar to EXAMPLE 1a, except that Modifier 7 (0.65 mL and 0.35 mL) was added in the first and second titanations in place of Modifier-1.

### Example 8

This catalyst was made using a procedure similar to EXAMPLE 1a, except that Modifier 8 (0.9 mL and 0.45 mL) was added in the first and second titanations in place of Modifier-1.

### Propylene Polymerizations.

Batch bulk propylene phase polymerizations were performed in a 2 litre stainless steel autoclave at 71° C. while stirring at 450 revolutions per minute and with a reaction time of 1 hour. Triethylaluminium (TEAl) is used as a co-catalyst together with diisobutyldimethoxysilane as an external donor.

In a typical procedure, the dry, nitrogen-purged autoclave is charged with hydrogen (from a pressure drop of 1.7 MPa of a 100 mL vessel) and then with liquid propylene (900 mL). The mixture is bought to 39 C with stirring. Catalyst (6 mg), a heptane solution of TEAl (Al/Ti=1000) and a heptane solution of external donor (Al/Si=11) are quickly swept into the autoclave with a liquid propylene (400 mL) flush. The mixture is brought to polymerization temperature and held for 1 hour. The polymerization is terminated by venting the remaining propylene, and the polymer is dried in a vacuum oven.

### Results

The results are as shown in Table 1:

TABLE 1

| | | | | Modifier | | | | Powder |
|---|---|---|---|---|---|---|---|---|
| | | | | in | | MFR | | Bulk |
| | | Mg | Ti | catalyst | Yield | [g/10 | XS | Density |
| Ex. | Modifier | [wt %] | [wt %] | [wt %] | [kg/g] | min] | [wt %] | [g/cm] |
| 1a 1b 1c | 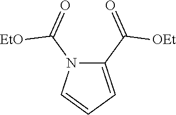 [SMILES: CCOC(=O)c1cccn1C(=O)OCC] | 18.6 17.9 17.6 | 2.24 1.83 2.16 | 9.1 11.5 1.2/10.7 IBIP | 8.4 25.0 31.7 | 35 19.1 16.3 | 10.68 8.04 n.d. | 0.336 0.449 0.47 |
| 1d | | 15.5 | 3.34 | n.d. | 31.1 | 9.6 | 3.14 | 0.453 |
| 2 | 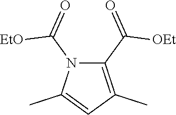 [SMILES: CCOC(=O)c1c(C)cc(C)n1C(=O)OCC] | 18.6 | 2.36 | 2.3 | 7.3 | n.d. | 17.4 | n.d. |
| 3 | 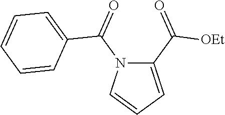 [SMILES: CCOC(=O)c1cccn1C(=O)c1ccccc1] | 16.9 | 2.18 | 12.4 | 8.8 | 46 | 2.9 | 0.374 |
| 4 | 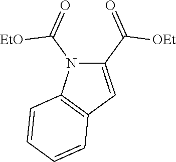 [SMILES: CCOC(=O)c1cc2ccccc2n1C(=O)OCC] | 18.5 | 2.08 | 7.0 | 12.8 | 39 | 8.2 | 0.44 |
| 5a 5b | 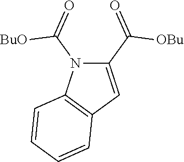 | 16.9 n.d | 2.23 n.d. | 12.4 16.2 | 20.4 15.5 | 24.8 21.3 | 8.4 9.4 | 0.356 0.39 |
| 6 | 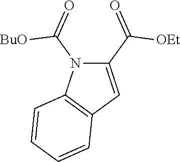 | 16.7 | 2.65 | 11.8 | 21.7 | 21.2 | 10.8 | 0.349 |
| 7 | 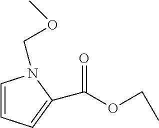 | 16.1 | 3.54 | n.d. | 18.38 | n.d. | 13.82 | n.d. |
| 8 | 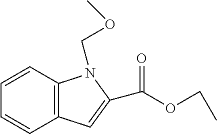 [SMILES: CCOC(=O)c1cc2ccccc2n1COC] | 14.9 | 4.46 | n.d. | 33.09 | n.d. | 19.44 | n.d. |

The metals composition of the catalysts are determined by ICP-OES (Induction Coupled Plasma-Optical Emission Spectrometry). For the purposes of the present invention a sample of the catalyst was digested in a sealed bomb under microwave irradiation with a matrix of hydrochloric, nitric, and hydrofluoric acids. The resulting product was filtered and the content of the filtrate was analysed in an ICP spectrometer. “Yield” (kg of polymer produced per g of solid catalyst component) is based on the weight of solid catalyst used to produce polymer. The viscosity of the solid polymer was measured according to ASTM D1238 Condition L (2.16 kg@230° C.) and reported as the melt flow rate (MFR) in grams of polymer per 10 minutes. “Xylene Solubles” are determined by evaporating xylene from an aliquot of filtrate to recover the amount of soluble polymer produced and are reported as the weight percent (wt %) of such soluble polymer based on the sum of the weights of the solid polymer isolated by filtration and of the soluble polymer. The powder bulk density is reported in units of grams per cubic centimetre (g/cc). “n.d.” means no data/not determined.

The results show that the catalysts in each case produced polypropylene in good yield.

1. A solid, hydrocarbon-insoluble, catalyst composition containing magnesium, titanium, and halogen and further comprising a modifier compound with a structure (1): 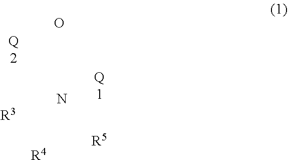
wherein Q1 is an oxygen containing group selected from CH₂—O—R¹, C(═O)—R¹ and C(═O)—O—R¹ and Q2 is selected from R² and O—R²; R¹ to R⁵ each being independently selected from H, alkyl, aryl, allyl, alkaryl, arylalkyl groups, optionally comprising one or more heteroatoms.

2. The catalyst composition according to claim 1 wherein the solid, hydrocarbon-insoluble, catalyst composition is a solid, hydrocarbon-insoluble, catalyst component comprising the modifier compound with the structure (1) as an internal modifier.

3. The catalyst composition according to claim 1 wherein none of R¹ to R⁵ comprise heteroatoms.

4. The catalyst composition according to claim 1 wherein R¹ and R² are alkyl.

5. The catalyst composition according to claim 1 wherein Q2 is O—R².

6. The catalyst composition according to claim 1 wherein Q1 is selected from C(═O)—R¹ and C(═O)—O—R¹.

7. The catalyst composition according to claim 6 wherein Q1 is C(═O)—O—R¹.

8. The catalyst composition according to claim 7 wherein Q2 is O—R², R¹ and R² are ethyl and wherein either:
i) R³ to R⁵ are all H, or
ii) R³ and R⁵ are methyl and R⁴ is H.

9. The catalyst composition according to claim 6 wherein Q1 is C(═O)—R¹.

10. The catalyst composition according to claim 9 wherein Q2 is O—R², R¹ phenyl, R² is ethyl and R³ to R⁵ are all H.

11. The catalyst composition according to claim 1 wherein Q1 is CH₂—O—R¹.

12. The catalyst composition according to claim 11 wherein Q2 is O—R², R¹ is methyl, R² is ethyl and R³ to R⁵ are all H.

13. The catalyst composition according to claim 1 wherein R⁴ and R⁵ are linked and the compound has the following structure (2): 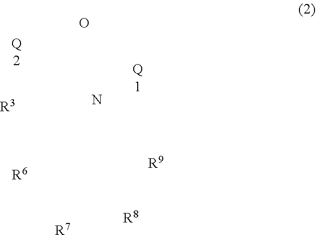
R⁶ to R⁹ each being independently selected from H, alkyl, aryl, allyl, alkaryl, arylalkyl groups, optionally comprising one or more heteroatoms.

14. The catalyst composition according to claim 13 wherein either:
(A) Q1 is C(═O)—O—R¹, R¹ being ethyl; Q2 is O—R², R² being ethyl; R³ and R⁶ to R⁹ are all H,
(B) Q1 is C(═O)—O—R¹, R¹ being butyl; Q2 is O—R², R² being butyl; R³ and R⁶ to R⁹ are all H,
(C) Q1 is C(═O)—O—R¹, R¹ being butyl; Q2 is O—R², R² being ethyl; R³ and R⁶ to R⁹ are all H, or
(D) Q1 is CH₂—O—R¹, R¹ being methyl; Q2 is O—R², R² being ethyl; R³ and R⁶ to R⁹ are all H.

15. A process to polymerize propylene or a mixture of propylene and ethylene or a C₄-C₅ alpha-olefin, which process comprises using the catalyst composition according to claim 1.

16. A process to polymerize propylene or a mixture of propylene and ethylene or a C₄-C₅ alpha-olefin, which process comprises using the catalyst composition according to claim 6.

17. A process to polymerize propylene or a mixture of propylene and ethylene or a C₄-C₅ alpha-olefin, which process comprises using the catalyst composition according to claim 8.

18. A process to polymerize propylene or a mixture of propylene and ethylene or a C₄-C₅ alpha-olefin, which process comprises using the catalyst composition according to claim 10.

19. A process to polymerize propylene or a mixture of propylene and ethylene or a C₄-C₅ alpha-olefin, which process comprises using the catalyst composition according to claim 12.

20. A process to polymerize propylene or a mixture of propylene and ethylene or a C₄-C₅ alpha-olefin, which process comprises using the catalyst composition according to claim 14.
